(19) United States
(12) Patent Application Publication
(10) Pub. No.: US 2010/0313615 A1
(43) Pub. Date: Dec. 16, 2010

(54) Electronic Lock

(75) Inventor: Ming-Tsun Chen, Kaohsiung City (TW)

Correspondence Address: ABELMAN, FRAYNE & SCHWAB, 666 THIRD AVENUE, 10TH FLOOR, NEW YORK, NY, 10017, US

(73) Assignee: Hwan Ming Enterprise Co., Ltd.

(21) Appl. No.: 12/484,683

(22) Filed: Jun. 15, 2009

(51) Int. Cl. E05B 47/02; E05B 47/00

(52) U.S. Cl. 70/276; 70/277

(57) ABSTRACT

An electronic lock includes: an elongated lock case formed to have an opening, and formed thereinside with a bobbin-receiving space and a first passage; an annular bobbin with a middle passage, and disposed such that the middle passage is coaxially and spatially communicating with the first passage to serve as a second passage; a coil being operable to generate a magnetic field inside the second passage; a driving body configured such that when the magnetic field is generated by the coil, the driving body is repulsed by the magnetic field to move toward the opening; a latch body configured such that when the coil generates the magnetic field, the latch body is driven to move from an unlatching position to a latching position; and a spring for storing a restoring force when the latch body moves from the unlatching position to the latching position.

### BACKGROUND OF THE INVENTION

1. Field of the Invention

This invention relates to an electronic lock that can be locked and unlocked electrically.

2. Description of the Related Art

An electronic door lock is usually disposed inside a door panel that has a limited thickness, and thus, a latch body, which is for latching together the door panel and a door frame, cannot be directly driven by a solenoid valve that occupies a relatively large volume. Accordingly, in order to conduct door locking and unlocking operations, it is necessary to dispose a connection lever between the latch body and the solenoid valve to be driven by the solenoid valve and to move the latch body. Such electronic door locks are disclosed in, for example, Taiwan patent publication nos. 313185, 366947, 409757, 568151, 575054, M252774, M261566, M274416, and M280404.

For example, as shown in FIGS. 1 and 2, a conventional electronic lock, which is disposed inside an opening 141 of a door panel 14, disclosed in Taiwan patent publication no. 568151 comprises: a lock case 11, a solenoid valve 12 with a plunger 121, a connection lever 113 moved with the plunger 121, a latch body 111 moved with the connection lever 113, a spring 112 disposed around an outer surface of the latch body 111, and a circuit board 13 that is electrically connected to the solenoid valve 12. The latch body 111 is driven by the solenoid valve 12 through the connection lever 113 to conduct door locking and unlocking operations.

As shown in FIG. 1, the electronic lock is normally in a locking state. At this time, the connection lever 113 is moved upwardly by extension of the plunger 121, and the latch body 111 is supported at a latching position and is inserted into a latch hole 151 in a door frame 15. The spring 112 is also compressed to store a restoring force.

When an open-door signal is transmitted to the solenoid valve 12 by the circuit board 13, the connection lever 113 falls back due to retraction of the plunger 121 of the solenoid valve 12. At this time, the restoring force stored by the spring 112 restores the latch body 111 to an unlatching position to unlock the door 14.

However, the conventional electronic lock occupies a larger volume and cannot be installed into the door panel 14 through the opening 141 thereof. Therefore, the installation and repair of the conventional electronic lock are relatively difficult. Besides, because the latch body 111 is driven by the solenoid valve 12 through the connection lever 113 in the conventional electronic lock, an erroneous operation tends to take place, and a longer response time between the generation of the open-door signal and the unlatching of the latch body 111 is required.

### SUMMARY OF THE INVENTION

Therefore, an object of the present invention is to provide an electronic lock that can overcome the aforesaid drawbacks associated with the prior art.

Accordingly, an electronic lock of the present invention comprises: an elongated lock case that has two ends, one end thereof being formed to have an opening, and that is formed thereinside with a bobbin-receiving space and a first passage for spatially communicating the opening with the bobbin-receiving space; an annular bobbin with a middle passage extending therethrough, the bobbin being disposed in the bobbin-receiving space such that the middle passage is coaxially and spatially communicating with the first passage to serve as a second passage; a coil wound on the bobbin and operable to generate a magnetic field inside the second passage; a driving body made of a permanent magnet, at least one part of which is disposed in the second passage, and which is configured such that when the magnetic field is generated by the coil, the driving body is repulsed by the magnetic field to move toward the opening; an elongated latch body with two ends, disposed in the first passage, and connected to the driving body at one end thereof, the other end of the latch body extending toward the opening, the latch body being configured such that when the coil generates the magnetic field, the latch body is driven by movement of the driving body so as to move along the first passage from an unlatching position, where the latch body is retracted into the first passage so as to place the latch body in an unlatchable state, to a latching position, where the latch body extends out of the first passage via the opening so as to place the latch body in a latchable state; and a spring disposed in the lock case for storing a restoring force when the latch body moves from the unlatching position to the latching position, the restoring force restoring the latch body to the unlatching position when the coil ceases to generate the magnetic field.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a cross-sectional view of a conventional electronic lock in a locking state;

FIG. 2 is a cross-sectional view of the electronic lock of FIG. 1 in an unlocking state;

FIG. 3 is a cross-sectional view of the preferred embodiment of an electronic lock, which is in an unlocking state, according to the present invention;

FIG. 4 is a cross-sectional view of the electronic lock of FIG. 3 in a locking state; and

FIG. 5 is a schematic view illustrating the installation of the electronic lock according to the present invention.

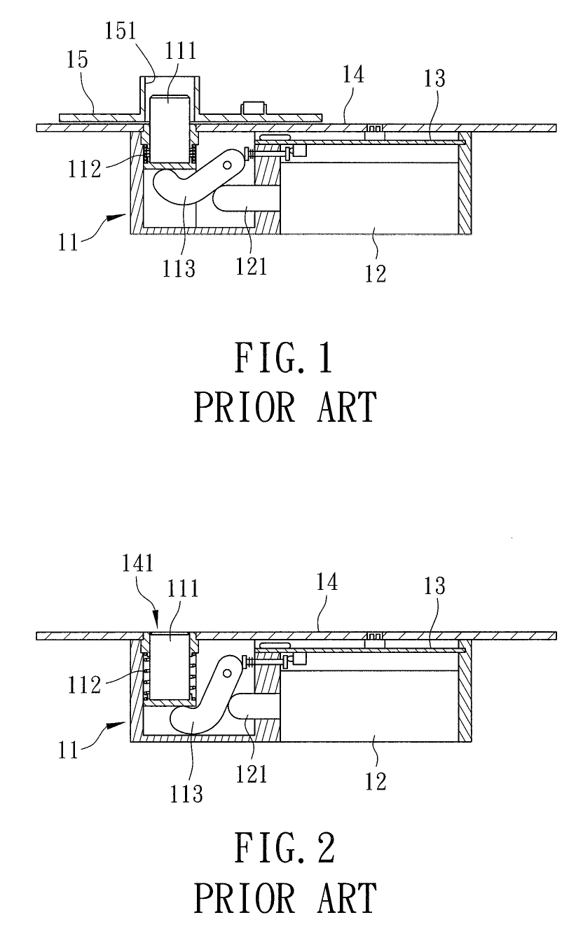

### DETAILED DESCRIPTION OF THE PREFERRED EMBODIMENT

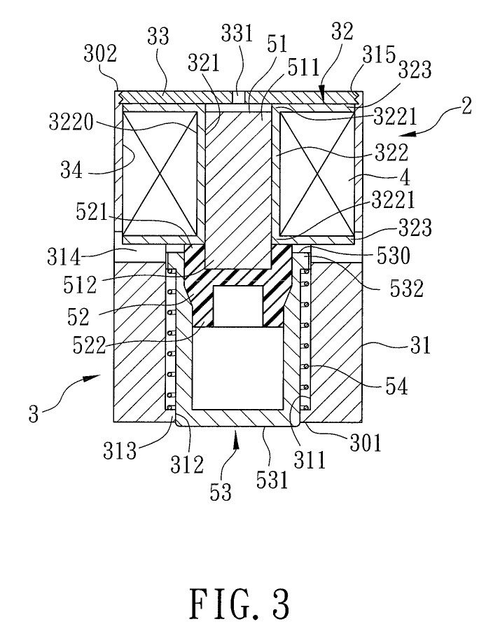

Referring to FIG. 3, the preferred embodiment of an electronic lock 2 of the present invention is shown to include an elongated lock case 3, an annular bobbin 32, a coil 4 wound on the bobbin 32, a driving body 51, a connection body 52, an elongated latch body 53, and a spring 54.

The lock case 3 has two ends 301, 302. One end 301 is formed to have a first opening 312 for passage of the latch body 53. The other end 302 is formed to have a second opening 315 and a cover 33 to cover the second opening 315. Furthermore, the lock case 31 is formed thereinside with a bobbin-receiving space 34 and a first passage 311 for spatially communicating the first opening 312 with the bobbin-receiving space 34.

The bobbin 32 includes a tube part 322 with a middle passage extending therethrough, and two flange parts 323. The tube part 322 has an outer surface 3220 with two edges 3221. The two flange parts 323 protrude outwardly from the two edges 3221, respectively. The bobbin 32 is disposed in the bobbin-receiving space 34 such that the middle passage is coaxially and spatially communicating with the first passage 311 to serve as a second passage 321.

The coil 4 is wound on the outer surface 3220 of the tube part 322, and is confined between the two flange parts 323. The coil 4 is operable to generate a magnetic field inside the second passage 321, when it is energized.

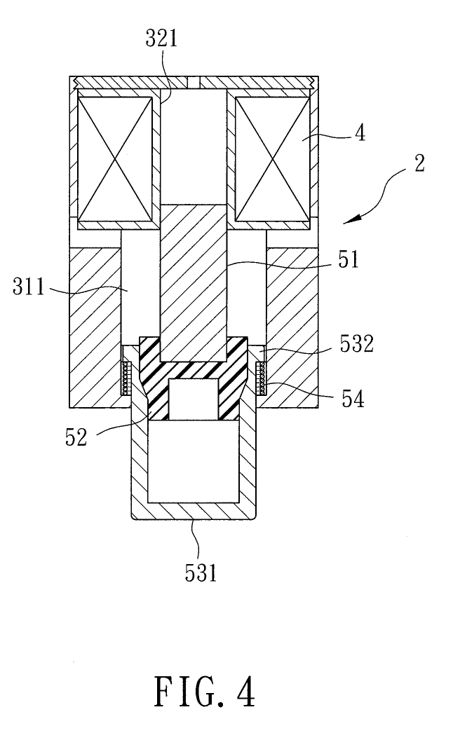

The driving body 51 is made of a permanent magnet, and at least one part thereof is disposed in the second passage 321. In the embodiment, when the coil 4 ceases to generate the magnetic field, a large part 511 of the driving body 51 is disposed in the second passage 321, and an end part 512 of the driving body 51 is disposed in the first passage 311. On the other hand, when the magnetic field is generated by the coil 4, the driving body 51 is repulsed by the magnetic field to move toward the first opening 312, as best shown in FIG. 4.

The connection body 52 has two ends 521, 522. One end 521 of the conection body 52 fittingly engages the end part 512 of the driving body 51, and the other end 522 of the connection body 52 is connected to the latch body 53. Furthermore, for preventing magnetic leakage from the driving body 51, the connection body 52 is made of a non-magnetically permeable material.

The latch body 53 has two ends 530, 531, is disposed in the first passage 311, and is connected to the driving body 51 through the connection body 52 at one end 530 thereof. The other end 531 of the latch body 53 extends toward the first opening 312. The latch body 53 is configured such that when the coil 4 generates the magnetic field, the latch body 53 is driven by movement of the driving body 51 so as to move along the first passage 311 from an unlatching position (as shown in FIG. 3) to a latching position (as shown in FIG. 4). When the latch body 53 is at the unlatching position (i.e., the electronic lock 2 is in an unlocking state), it is retracted into the first passage 311 so as to place the latch body 53 in an unlatchable state. When the latch body 53 is at the latching position (i.e., the electronic lock 2 is in a locking state), it extends out of the first passage 311 via the first opening 312 so as to place the latch body 53 in a latchable state.

In the preferred embodiment, the electronic lock 2 further comprises first and second annular flanges 532, 313. The first annular flange 532 is disposed along an outer circumference of the end 530 of the latch body 53. The second annular flange 313 is disposed along an inner circumference of the end 301 of the lock case 3, and defines the first opening 312 in spatial communicating with the first passage 311.

The spring 54 is disposed in the lock case 3 and around an outer surface of the latch body 53 such that the spring 54 is limited between the first and second annular flanges 532, 313. Furthermore, when the latch body 53 moves from the unlatching position to the latching position, the spring 54 is compressed by the reduced distance between the first and second annular flanges 532, 313 to store a restoring force. The restoring force restores the latch body 53 to the unlatching position when the coil 4 ceases to generate the magnetic field.

In the preferred embodiment, the lock case 3 has two first ventholes 314 and a second venthole 331 formed therein. The two first ventholes 314 are spatially communicated with the first passage 311, and the second venthole 331 is spatially communicated with the second passage 321. The lock case 3 is constituted by a case body 31 and the cover 33. Preferably, the two first ventholes 314 are formed in the case body 31, and the second venthole 331 is formed in the cover 33. Accordingly, when the electronic lock 2 is switching between locking and unlocking states (i.e., the driving body 51 and the latch body 53 move in the first and second passages 311, 321), the provision of the first and second ventholes 314, 331 permits air to flow into and out of the lock case 3, such that the switching of the electronic lock 2 will proceed more smoothly.

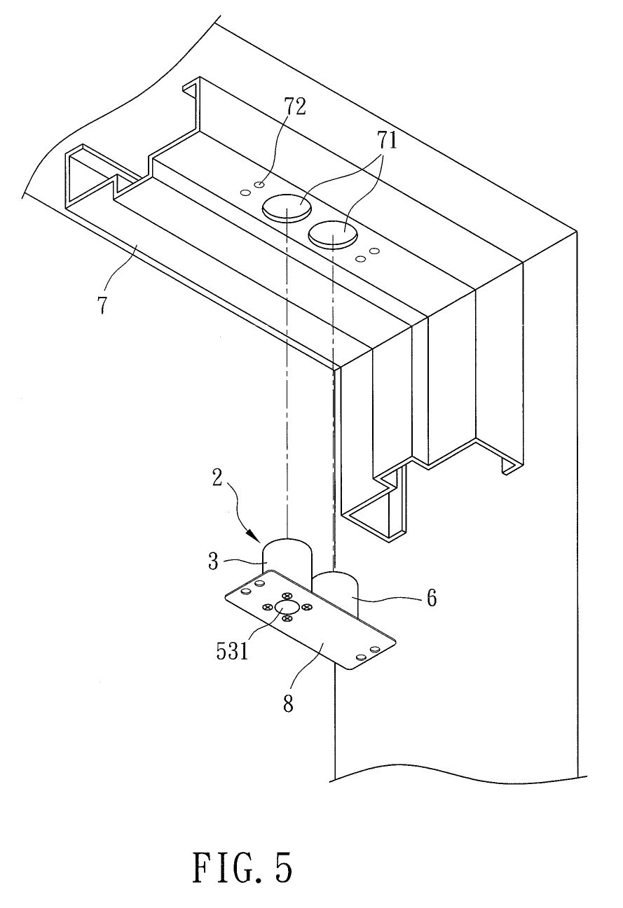

Moreover, as shown in FIG. 5, the electronic lock 2 of the preferred embodiment is fastened on a fixing plate 8, and is electrically connected to a driving circuit device 6 disposed on the fixing plate 8 and used to drive the coil 4 to generate the magnetic field. It is only required to provide a door frame 7 with two installation holes 71, which are for extension of the electronic lock 2 and the driving circuit device 6, respectively, and a plurality of screw holes 72, which are for fastening the fixing plate 8 onto the door frame 7. Thus, the electronic lock 2 and the driving circuit device 6 can be easily mounted in the door frame 7 via the installation holes 71. Similarly, the electronic lock 2 can be easily removed from the door frame 7 for repair.

When the electronic lock 2 is in a state of use, it is normally in a locking state, i.e., the latch body 53 is normally in the latching position. When an open-door signal generated by a certification device (for example, a fingerprint certification device) is received by the driving circuit device 6, the coil 4 ceases to generate the magnetic field, and the restoring force stored by the spring 54 restores the latch body 53 to the unlatching position to open the door. Thereafter, the coil 4 may be energized one again to generate the magnetic field, so as to drive the latch body 53 to move to the latching position.

By replacing the solenoid valve, which occupies a relatively large volume, with the coil 4 wound on the bobbin 32, it is not necessary to drive the latch body 53 through a connection lever disposed between the latch body 53 and the driving body 51. That is to say, the latch body 53 is directly driven by the driving body 51 and moves together with the driving body 51. As a result, there is no erroneous operation attributed to the connection lever in this invention, and the response time between the generation of the open-door signal and the unlatching operation of the latch body 53 can be reduced. Besides, the installation and repair of the electronic lock 2 without the solenoid valve is easier than in the prior art.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. An electronic lock, comprising:
an elongated lock case that has two ends, one end thereof being formed to have a first opening, and that is formed thereinside with a bobbin-receiving space and a first passage for spatially communicating said first opening with said bobbin-receiving space;
an annular bobbin with a middle passage extending therethrough, said bobbin being disposed in said bobbin-receiving space such that said middle passage is coaxially and spatially communicating with said first passage to serve as a second passage;
a coil wound on said bobbin and operable to generate a magnetic field inside said second passage;
a driving body made of a permagnet magnet, at least one part of which is disposed in said second passage, and which is configured such that when the magnetic field is generated by said coil, said driving body is repulsed by the magnetic field to move toward said first opening;
an elongated latch body with two ends, disposed in said first passage, and connected to said driving body at one end thereof, the other end of said latch body extending toward said first opening, said latch body being configured such that when said coil generates the magnetic field, said latch body is driven by movement of said driving body so as to move along said first passage from an unlatching position, where said latch body is retracted into said first passage so as to place said latch body in an unlatchable state, to a latching position, where said latch body extends out of said first passage via said first opening so as to place said latch body in a latchable state; and
a spring disposed in said lock case for storing a restoring force when said latch body moves from the unlatching position to the latching position, the restoring force restoring said latch body to the unlatching position when said coil ceases to generate the magnetic field.

2. The electronic lock of claim 1, further comprising a connection body made of a non-magnetically permeable material, wherein said one end of said latch body is connected to said driving body through said connection body.

3. The electronic lock of claim 1, wherein said spring is disposed around an outer surface of said latch body.

4. The electronic lock of claim 3, further comprising first and second annular flanges,
said first annular flange being disposed along an outer circumference of said one end of said latch body,
said second annular flange being disposed along an inner circumference of said one end of said lock case, and defining said first opening in spatial communication with said first passage,
said spring being limited between said first and second annular flanges.

5. The electronic lock of claim 1, wherein:
said bobbin includes a tube part having an outer surface with two edges, and two flange parts outwardly protruding from said two edges, respectively; and
said coil is wound on said outer surface of said tube part, and is confined between said two flange parts.

6. The electronic lock of claim 1, wherein said lock case has first and second ventholes formed therein, said first venthole being spatially communicated with said first passage, said second venthole being spatially communicated with said second passage.

7. The electronic lock of claim 6, wherein said other end of said lock case is formed with said second venthole.

8. The electronic lock of claim 6, wherein said other end of said lock case is formed to have a second opening and a cover to cover said second opening, said second venthole being formed in said cover.
